(19) United States
(12) Patent Application Publication
(10) Pub. No.: US 2012/0258282 A1
(43) Pub. Date: Oct. 11, 2012

(54) Asphalt Shingle with Lightweight Structural Aggregate and Method for Making Same

(75) Inventor: Joel D. Hammond, Marietta, GA (US)

(73) Assignee: BIG RIVER INDUSTRIES, INC., Alpharetta, GA (US)

(21) Appl. No.: 13/083,678

(22) Filed: Apr. 11, 2011

(51) Int. Cl. D06N 7/04; C03B 29/00

(52) U.S. Cl. 428/143; 156/89.11

(57) ABSTRACT

A shingle includes a reinforcing mat layer, an asphalt layer and an exterior layer. The asphalt layer is on top of the mat layer. The exterior layer includes structural-grade lightweight aggregate granules that are disposed on top of the asphalt layer. In making a roofing shingle, a mineral composition is heated to cause the mineral composition to fuse. The fused and expanded mineral composition is milled to form lightweight structural-grade aggregate granules. An asphalt layer is deposited onto a top surface of a reinforcing mat layer. A layer of structural-grade lightweight aggregate granules is applied onto the top layer. An adhesive asphalt strip is applied onto the layer of structural-grade lightweight aggregate granules. A lightweight aggregate pulverized dust is applied to a bottom surface of the mat layer.

### BACKGROUND OF THE INVENTION

1. Field of the Invention

The present invention relates to construction materials and, more specifically, to an asphalt shingle and a method for making the same.

2. Description of the Related Art

Asphalt shingles are the most widely used type of roofing shingle in the United States due to their low cost and ease of installation. A typical asphalt shingle includes a reinforcing mat layer, an asphalt layer disposed on the mat layer, a granule layer disposed on the asphalt layer and an asphalt adhesive strip disposed on the granule layer.

The reinforcing mat layer is usually made from either an organic felt or fiberglass and is saturated with asphalt. The asphalt in the reinforcing mat layer makes the shingle waterproof. The granule layer includes a plurality of crushed rock granules (such as limestone granules) and provides protection from sunlight. Pigment may be applied to some of the granules to give the shingle a desired color. The asphalt adhesive strip is applied across a portion the top surface (or the bottom surface in certain embodiments) of the shingle and seals each shingle to overlapping shingles when installed on a roof.

Architectural shingles are asphalt shingles that employ a thicker mat layer than standard shingles (sometime referred to as “three-tab shingles”) and may include several layers that are laminated together. As a result, such shingles are stronger than typical three-tab shingles and resist wind damage. Also, because of their thickness, architectural shingles may also include accents that make them more aesthetically appealing.

Asphalt shingles can be quite heavy, ranging in weight from about 80 lbs. per bundle, for three-tab shingles, to over 140 lbs. per bundle, for high end laminated architectural shingles. Once installed, the shingles put a considerable load on the building structure. For example, a 1500 square foot roof would require about 50 bundles of shingles. If architectural shingles were used, this would result in 7,000 lbs. of dead load being added to the roof from the shingles alone.

Also, when installing shingles, the installer typically lifts bundles of shingles to a roof using a portable elevator. However, the installer must then carry the bundle manually to the location where shingles are currently being installed. Given that many bundles must be used to shingle a single roof, the carrying of shingle bundles can be quite fatiguing. Also, many roofs are steep and carrying such heavy shingle bundles on steep inclines can be hazardous.

Therefore, there is a need for lightweight asphalt shingles.

### SUMMARY OF THE INVENTION

The disadvantages of the prior art are overcome by the present invention which, in one aspect, is a shingle that includes a reinforcing mat layer, a asphalt layer and an exterior layer. The asphalt layer is disposed on top of the mat layer and includes asphalt. The exterior layer is a layer of structural-grade lightweight aggregate granules that is disposed on top of the asphalt layer.

In another aspect, the invention is a shingle with a reinforcing mat layer that includes an organic fabric that is saturated with asphalt. A granule-asphalt layer is disposed on top of the mat layer and includes a plurality of structural-grade lightweight aggregate granules that are suspended in asphalt. An exterior layer of structural-grade lightweight aggregate granules is disposed on top of the asphalt layer. A structural-grade lightweight aggregate pulverized lubricating dust is applied to the bottom side of the shingle.

In yet another aspect, the invention is a method of making a roofing shingle, in which a mineral composition is heated to a preselected temperature for an amount of time sufficient to cause the mineral composition to bloat or expand, thereby generating a fused and expanded mineral composition. The fused and expanded mineral composition is milled so as to form lightweight structural-grade aggregate granules. An asphalt layer is deposited onto a top surface of a reinforcing mat layer. A layer of structural-grade lightweight aggregate granules is applied onto the asphalt layer and a roller presses the granules into the asphalt layer. An adhesive asphalt strip is applied onto the layer of structural-grade lightweight aggregate granules. A selected amount of fused and expanded mineral composition is pulverized into a lightweight aggregate lubricating dust. The lightweight aggregate lubricating dust is applied to a bottom surface of the mat layer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a plan view of an asphalt shingle employing lightweight structural aggregate.

FIG. 1B is a cross sectional view of the shingle shown in FIG. 1A taken along line 1B-1B.

FIG. 1C is a cross sectional view of an alternate embodiment of the shingle shown in FIG. 1A taken along line 1B-1B.

FIG. 2A-2C are a series of schematic diagrams showing one method of making a roofing shingle.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

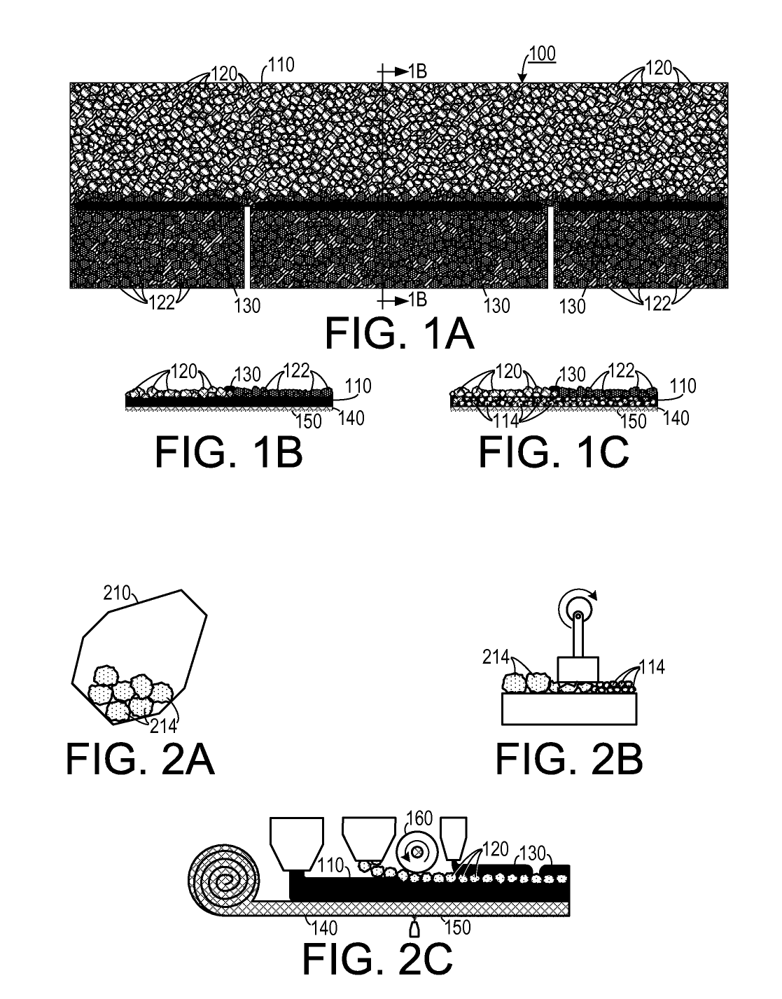

As shown in FIGS. 1A and 1B, one embodiment of a light weight shingle 100 includes a reinforcing mat layer 140, which could include fiberglass or an organic material that has been saturated with asphalt. An asphalt layer 110 is disposed on the top of the reinforcing mat layer 140. An exterior layer of structural-grade lightweight aggregate granules 120 (some of which are optionally dyed structural-grade lightweight aggregate granules 122) is disposed on top of the asphalt layer 110. Asphalt adhesive strips 130 (that cause each shingle to adhere to the shingle placed above it once the shingles are installed on a roof) are deposited on top of the shingle 100. A structural-grade lightweight aggregate lubricating dust 150 is applied to the bottom side of the shingle. In an alternate embodiment, as shown in FIG. 1C, a plurality of structural-grade lightweight aggregate granules 114 can be added to the asphalt layer 110 to form a granule-asphalt matrix 112.

Structural-grade lightweight aggregate is produced by gravity feeding certain clay, shale or slates through a rotary kiln where it is heated to approximately 2000° F. This causes moisture and gasses in the shale, slate or clay to expand, thereby creating voids in the material, while also causing the minerals in the material to fuse around the voids. The resulting material is milled into granules of a desired size. The granules have the strength and hardness of fired ceramic, but are much lighter due to the voids in the granules.

One method of making a shingle is shown in FIGS. 2A-2C, in which a mineral material 214, such as clay, is placed in a rotary kiln 210 and heated to a temperature (of approximately 2000° F.) for an amount of time to cause the mineral material 214 to expand and fuse. The expanded and fused mineral material 214 is milled or ground into structural-grade lightweight aggregate granules 114. An asphalt layer 110 is deposited onto a reinforcing mat 140. Structural-grade lightweight aggregate granules 120 are deposited onto the asphalt layer 110 and the granules 120 are pressed into the asphalt layer 110 with a roller 160. Asphalt adhesive strips 130 are deposited on top of portions of the layer of structural-grade lightweight aggregate granules 120. A pulverized lubricating dust 150 made of finely ground lightweight aggregate is applied to the bottom side of the mat layer 140. This pulverized lubricating dust 150 helps to keep the shingles from sticking to each other once they are stacked for packaging.

The shingle disclosed herein is lighter than conventional shingles for several reasons. First, the lightweight aggregate granules 120 (and optionally dyed granules 122) are lighter than typical granules (such as limestone, rock, slag and coal ash granules) used on the top surface of conventional shingles. Second, the lightweight aggregate pulverized lubricating dust 150 is lighter than the traditional dust used to coat the back side of conventional shingles. The lightness of the shingles disclosed herein can reduce dead weight loading, worker fatigue and transport costs substantially, while resulting in a shingle that is as strong as conventional shingles.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A shingle, comprising:
a. a reinforcing mat layer;
b. an asphalt layer, disposed on top of the mat layer; and
c. an exterior layer of structural-grade lightweight aggregate granules disposed on top of the granule-asphalt layer.

2. The shingle of claim 1, further comprising a pulverized structural-grade lightweight aggregate pulverized dust applied to the bottom side of the shingle.

3. The shingle of claim 1, wherein the reinforcing mat layer is saturated with asphalt.

4. The shingle of claim 1, wherein the reinforcing mat layer comprises an organic material.

5. The shingle of claim 4, wherein the organic material comprises a fabric that is saturated with asphalt.

6. The shingle of claim 1, wherein the reinforcing mat layer comprises fiberglass.

7. The shingle of claim 1, further comprising a plurality of structural-grade lightweight aggregate granules that are suspended in asphalt layer.

8. A shingle, comprising:
a. a reinforcing mat layer that includes an organic fabric that is saturated with asphalt;
b. a granule-asphalt layer, disposed on top of the mat layer, that includes a plurality of structural-grade lightweight aggregate granules that are suspended in asphalt;
c. an exterior layer of structural-grade lightweight aggregate granules disposed on top of the asphalt layer; and
d. a structural-grade lightweight aggregate lubricating dust applied to the bottom side of the shingle.

9. A method of making a roofing shingle, comprising the steps of:
a. heating a mineral composition to a preselected temperature for an amount of time sufficient to cause the mineral composition to fuse, thereby generating a fused and expanded mineral composition;
b. milling the fused and expanded mineral composition so as to form lightweight structural-grade aggregate granules;
c. depositing a layer of asphalt onto a top surface of a reinforcing mat layer;
d. applying a layer of the structural-grade lightweight aggregate granules onto the layer of asphalt;
e. pressing the layer of the structural-grade lightweight aggregate granules into the layer of asphalt;
f. applying an adhesive asphalt strip onto the layer of structural-grade lightweight aggregate granules;
g. grinding a selected amount of fused and expanded mineral composition into a lightweight aggregate pulverized dust; and
h. applying the lightweight aggregate pulverized dust to a bottom surface of the mat layer.

10. The method of claim 9, further comprising the step of mixing some of the lightweight structural-grade aggregate granules with the asphalt layer, thereby forming an asphalt-lightweight aggregate mixture.

11. The method of claim 9, further comprising the step of saturating an organic fabric with asphalt so as to form the reinforcing mat layer.
